(19) United States
(12) Patent Application Publication
(10) Pub. No.: US 2013/0318959 A1
(43) Pub. Date: Dec. 5, 2013

(54) Hydraulic Circuits with Energy Conservation Features for Overrunning Load Conditions

(71) Applicants: Tonglin Shang, Bolingbrook, IL (US); Jiao Zhang, Naperville, IL (US); Bryan Jacob Hillman, Peoria, IL (US); Vickram Murugesan, Joliet, IL (US)

(72) Inventors: Tonglin Shang, Bolingbrook, IL (US); Jiao Zhang, Naperville, IL (US); Bryan Jacob Hillman, Peoria, IL (US); Vickram Murugesan, Joliet, IL (US)

(73) Assignee: CATERPILLAR, INC., Peoria, IL (US)

(21) Appl. No.: 13/487,418

(22) Filed: Jun. 4, 2012

(51) Int. Cl. F16D 31/02

(52) U.S. Cl. 60/459

(57) ABSTRACT

A hydraulic system is disclosed that includes a hydraulic actuator having a head end, a rod end and a piston disposed therebetween. The system also includes a pump configured to supply fluid to both ends of the actuator. The system also includes an energy conservation system that is configured to reduce flow from the pump to the head end of the actuator and to increase flow from a make-up fluid circuit to the head end of the actuator during an overrunning load condition. The energy conservation system also increases flow from the pump to the head end of the actuator and decreases flow from the make-up circuit to the head end of the actuator after the overrunning load condition has ceased.

### TECHNICAL FIELD

The present disclosure relates to energy conservation, and more particularly to a system and method for conserving energy in a hydraulically powered linkage system.

### BACKGROUND

In a machine, such as an excavator or a backhoe, a hydraulic circuit may include a variable displacement pump in fluid communication with one or more hydraulic actuators to handle a variable load. The pump provides pressurized hydraulic fluid to each of the actuators, such as a hydraulic cylinder, to move the load. The actuators may be connected to work implements, such as a boom, stick, bucket and/or swing motor.

For example, right at the beginning of a digging cycle, the boom circuit transitions from a lowering operation to a lifting operation and the bucket and stick circuits have higher load demand from the pump. As a result, for a short period of time, about 0.5 to about 2 seconds, the boom circuit is in an overrunning condition. In the overrunning condition, the head end pressure of the actuator for the boom receives pump flow greater than what is necessary. This excessive pump flow is thus wasted and could have been directed to other functions when the flow is needed, such as the bucket circuit. Alternatively, the pump output energy could be reduced.

For example, US2007/0074509 discloses a system that recovers some energy by providing an accumulator for the pressurized fluid released from the head end of the actuator during an overrunning condition. However, such an accumulator increases the size of the machine. Further, the pressure in the accumulator may also be less than an ideal inlet pressure for the hydraulic pump. As a result, such a system may also require a charge pump to ensure that fluid at an appropriate pressure is delivered to the inlet of the hydraulic pump. Use of a charge pump is not energy efficient, and the use of additional components, such as accumulators and charge pumps, increase the cost of the machine.

Such a system has another shortcoming. Specifically, when the lift cylinder is being retracted and the accumulator is at a higher pressure than the fluid discharged from the lift cylinder, additional energy from the engine is required to store the fluid coming from the lift cylinder in the accumulator.

### SUMMARY OF THE DISCLOSURE

In one aspect, a hydraulic system is disclosed. The disclosed hydraulic system includes a hydraulic actuator that has a head end and a rod end. The disclosed system also includes a pump configured to supply fluid to the rod and head ends of the actuator. The system may further include a first valve fluidly coupled between the pump and the actuator. The system may also include a make-up circuit fluidly coupled between the return line and the head end of the actuator for communicating make-up fluid between the return line and the head end of the actuator. The system may also include a second valve fluidly coupled to the make-up circuit. The system may also have a first configuration where the actuator is moved from a retracted position to an extended position for a period of time. Wherein, for an initial segment of the period of time, the first valve may be operable to at least partially reduce the supply fluid being directed to the head end of the actuator by the pump and the second valve may be operable to at least partially permit make-up fluid to be directed from the return line to the head end of the actuator. Further, subsequent to the initial segment of the period of time, the first valve may be operable to at least partially permit supply fluid to be directed to the head end of the actuator by the pump and the second valve may be operable to at least partially inhibit make-up fluid from being directed to the head end of the actuator.

In another aspect, a machine is disclosed which may include a boom coupled to a work implement. The machine may also include a hydraulic system to actuate the boom and work implement. The hydraulic system may include a hydraulic actuator having a head end and a rod end. The hydraulic system may also include a head end pressure sensor, a rod end pressure sensor and a boom lever. The head end and rod end pressure sensors may be linked to a controller having a memory with a program stored therein for sending signals to the controller. The boom lever may also be linked to the controller for sending lever commands to the actuator. The program detects whether the hydraulic system is in an overrunning load condition based, at least in part, on signals received by the controller from pressure sensors at the head end and rod end of the actuator and/or a lever command. The hydraulic system may also include a pump configured to supply fluid to the rod and head ends of the actuator through at least one valve. The controller may be configured to control the at least one valve to reduce flow from the pump to the head end of the actuator and to increase flow from the make-up circuit to the head of the actuator when an overrunning load condition is detected. Further, the controller may be configured to control the at least one valve to increase flow from the pump to the head end of the actuator and to decrease flow from the make-up circuit to the head end of the actuator when the overrunning load condition has ceased.

In another aspect, a method for conserving energy in a hydraulic system including a pump, a hydraulic actuator having a head end and a rod end, a head end pressure sensor, a rod end pressure sensor, a boom lever and at least one valve disposed between the pump and the actuator. The disclosed method may include detecting when the hydraulic system is in an overrunning load condition; reducing fluid flow to the head end of the actuator and increasing fluid flow from the make-up circuit to the head end of the actuator by at least partially closing the at least one valve; and increasing fluid flow to the head end of the actuator and decreasing fluid flow from the make-up circuit to the head end of the actuator when the overrunning load condition has ceased by at least partially opening the at least one valve.

In any one or more of the embodiments described above, the system may further include a head end pressure sensor and a rod end pressure sensor.

In any one or more of the embodiments described above, the system may further include a boom lever linked to the controller for sending lever commands to the controller. The head and rod end pressure sensors may be linked to the controller. The controller may have a memory with a program stored therein. The program may detect whether or not the hydraulic system is in an overrunning load condition based on signals received by the controller from the head and rod end pressure sensors and/or a lever command received from the boom lever.

In any one or more of the embodiments described above, the first valve may be at least partially closed during an overrunning load condition. In a further refinement of this concept, the second valve may be at least partially open during an overrunning load condition.

In any one or more of the embodiments described above, the first valve may be a bidirectional control valve disposed between the pump and the head end of the actuator and a second valve may be disposed between the first valve and the pump. In a further refinement of this concept, the controller may at least partially close the second valve during overrunning load conditions and open the second valve when an overrunning load condition has ceased.

In any one or more of the embodiments described above, the controller is part of an engine control module (ECM).

In any one or more of the embodiments described above, the pump is a one-way pump.

In any one or more of the embodiments described above, a first bidirectional control valve provides flow from the pump to the head end of the actuator when the bidirectional control valve is in an open position.

In any one or more of the embodiments described above, the first bidirectional control valve may be adjusted from a fully closed position to a fully open position with a plurality of positions therebetween.

In those embodiments with first and second valves disposed between the head end of the actuator and the pump, the second valve may be opened during an overrunning load condition to increase flow from the return line to the head end of actuator and the second valve may be closed when the overrunning load condition has ceased.

### BRIEF DESCRIPTION OF THE DRAWINGS

FIG. 1 is a schematic and diagrammatic representation of a hydraulic system for conserving energy according to one exemplary embodiment; and

FIG. 2 is a schematic and diagrammatic representation of another hydraulic system for conserving energy according to another exemplary embodiment.

### DETAILED DESCRIPTION

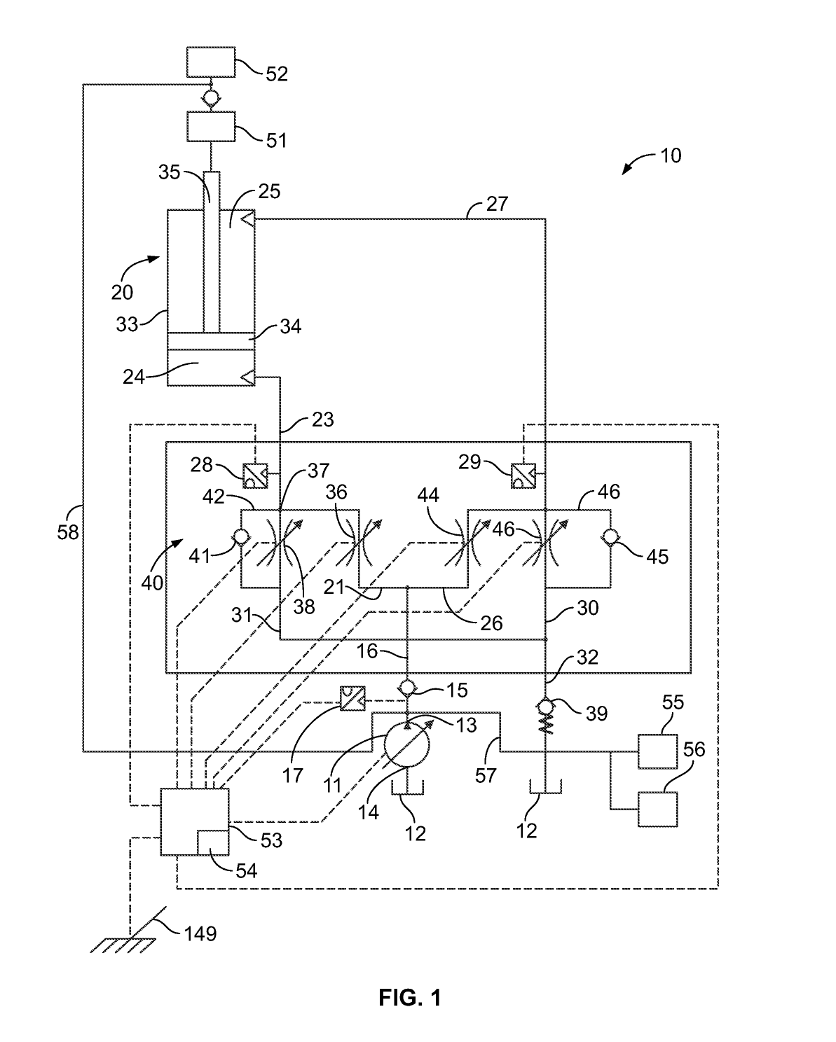

Turning to FIG. 1, a hydraulic system 10 is shown that may be part of an excavator, a loader or another piece of equipment utilizing a hydraulic system. The system 10 includes a pump 11, typically driven by a power source (not shown), such as an internal combustion engine, via a drive train or shaft (also not shown). In the exemplary embodiment shown in FIG. 1, the pump 11 may be a variable displacement and unidirectional pump. The pump 11 may be in communication with a fluid reservoir 12 that also serves as a drain as shown in FIG. 1. The pump 11 may include a rotatable cylinder barrel having multiple pistons bores (not shown), a tiltable swash plate (not shown), pistons (not shown) held against the tiltable swash plate, an outlet port 13 and an inlet port 14. A back pressure check valve 15 may be disposed in the pump outlet line 16. The pressure sensor 17 may be used to measure the pressure at the outlet 13 of the pump 11.

The system 10 may also include an actuator 20 that includes a head end 24 that is in fluid communication with the pump 11 via the lines 16, 21 and 23. The rod end 25 of the actuator 20 may be in communication with the pump 11 via the lines 16, 26 and 27. Pressure sensors 28, 29 may be used to measure the pressures in the lines 23, 27 respectively. The system 10 may also include other functions such as a bucket 52 and associated bucket circuit (not shown), a stick 55 and associated stick circuit (not shown), and another circuit 56 such as a swing circuit. To this end, the system 10 may include one or more pumps 11 that direct combined pressurized fluid to one or more of the circuits. In one example, the pump 11 may be primarily associated with the boom 51 and the bucket 52 circuits and secondarily associated with the stick 55 the other circuit 56.

The actuator 20 may also be in communication with the reservoir 12 as the head end 24 of the actuator 20 may be in communication with the reservoir 12 via the lines 23, 31 and 32 as shown in FIG. 1. The rod end 25 of the actuator 20 may be in communication with the reservoir 12 via the lines 27, 30 and 32 as shown in FIG. 1.

The actuator 20 may include a cylindrical body 33 that accommodates a piston 34 that separates the head end 24 from the rod end 25 of the actuator 20. The piston 34 may also be connected to the rod 35 which, in turn, may be coupled to the piece of equipment being moved which may, for example, the boom 51 of the machine that can perform a digging operation such as an excavator, backhoe, etc. As noted above, the boom 51 may be coupled to a work implement 52, such as a bucket 52. FIG. 1 further illustrates communication between the pump 11 and the stick 55 and another implement 56 via the line 57 and communication between the pump 11 and the bucket 52 via the line 58. Further, FIG. 1 also illustrates communication between the pressure sensors 28, 29, 17, the valves 38, 36, 44, 46 and the pump 11 with a controller 53.

FIG. 1 also illustrates a series of valves, the functions of which will be described in greater detail below. At the outset, when pumping fluid from the reservoir 12 to the head end 24 of the actuator 20, the pump 11 pumps fluid past the check valve 15 into the line 16 and through the first valve 36, which will hereinafter be referred to as the pump-cylinder-head-end (PCHE) valve 36. When pumping fluid into the head end 24 of the actuator 20, the PCHE valve 36 is open and, due to the junction 37 in the lines 23, 31, 21, the second valve 38, which will be referred to as the cylinder-tank-head-end (CTHE) valve 38, is closed. With the CTHE valve 38 closed, fluid may flow through the PCHE valve 36, past the junction 37, into the line 23 and into the head end 24 of the actuator 20. When the rod 35 is extended during a overrunning condition, with the PCHE valve 36 closed or partially open and the CTHE valve 38 open, pressurized return line fluid may leave the return line 31 by proceeding through the make-up valve 41 and the CTHE valve 38, through the junction 37 and through the line 23 to the head end 24 of the actuator 20. The make-up valve 41 may be used to provide make-up flow from return line 31 to head end 24 of actuator 20 during an overrunning condition.

Turning to the rod end 25 of the actuator 20, fluid may be pumped from the reservoir 12 to the rod end 25 via the pump 11, line 16, line 26 and line 27 after proceeding through the third valve 44 which will be referred to as the pump-cylinder-rod-end (PCRE) valve 44. Similar to the make-up valve 41 and the CTHE valve 38, a make-up valve 45 and cylinder-tank-rod-end (CTRE) valve 46 may be used to provide make-up flow from the return line 30 to the rod end 25 during an overrunning condition when the PCRE valve 44 is closed or partially open. To allow fluid to be released from the rod end 25 of the actuator 20 and returned to the reservoir 12, the fluid proceeds through the line 27 to the CTRE valve 46 and through the lines 30, 32 to the reservoir 12.

The energy conservation aspects of the system 10 when the actuator 20 is operating under an overrunning load condition will now be explained. First, an overrunning load condition may exist when the boom 51 has been extended to load material, such as a during digging operation. In the overrunning load condition, due to its extended position, the boom 51 may be extended under the force of the linkage induced by the bucket 52 and the stick 55. This extension causes the piston 34 to move towards the rod end 25 of the actuator 20 thereby resulting in pressurized hydraulic fluid in rod end 25 and a low pressure in the head end 24. The fluid that has been sent to the head end 24 of the actuator 20 is pressurized at the pump outlet port 13. Hence, if the PCHE valve 36 is opened and the fluid is allowed to pass through the lines 16, 21, past the PCHE valve 36 and line 23 to the head end 24 of the actuator 20 during an overrunning condition, the energy of this pressurized pump fluid will be lost. Further, the problem is exacerbated by the constant operation of the pump 11 which is providing pressurized fluid for other hydraulic systems in addition to the hydraulic system 10, such as the system shown schematically at 56 and the stick 55 through the line 57 and the bucket 52 through the line 58.

To minimize this energy loss, the controller 53 may be equipped with a memory 54 with software that can perform the following functions. First, the work condition of the actuator 20 may be detected using the head end 24 and rod end 25 pressure measurements provided by the pressure sensors 28, 29 respectively. A boom lever command instigated at the joystick or boom lever 49 may also be used to detect the actuator 20 work condition. During an overrunning load condition, the pressure in the head end 24 of the actuator 20 is close to or lower than the pressure in the return line 23. Thus, any pump flow delivered to the head end 24 of the actuator 20 is wasted energy. To overcome this problem, using make-up flow software and the make-up circuit which may include, CTHE valve 38, line 31, valve 41, line 42 and line 23. The PCHE valve 36 may be partially or fully closed and the otherwise wasted pump flow can be used for other functions or the pump flow can be reduced accordingly. Thus, the flow from the pump 11 to the boom 51 can be reduced during a digging mode and extra pump flow can be redirected to the work implement 52 through the line 58 to speed up the digging mode or to the stick 55 or to the other system 56 through the line 57.

Thus, when the boom 51 is in an overrunning load condition, the controller 53 may send a series of commands to at least partially close or fully close the PCHE valve 36 to reduce or stop flow from the pump 11 to the head end 24 of the actuator 20. The controller 53 may send a signal to at least partially open the CTHE valve 38 during the closing of the PCHE valve 36 to send pressurized fluid in return lines 31, 32 and past valves 38 and 41 to the head end 24 of actuator 20. As soon as the overrunning load condition is over or has ceased, generally in about 0.5 to about 2 seconds, as detected by the pressure sensors 28, 29, the controller 53 may then send a command to at least partially open or fully open the PCHE valve 36 to allow normal boom 51 operation. Thus, the system 10 as illustrated in FIG. 1 can conserve energy by limiting energy losses during an overrunning load condition by controlling the opening of at least one of the PCHE valve 36 and the CTHE valve 38 to inhibit flow from the pump 11 to the head end 24 of the actuator 20 such that the pressurized fluid being pumped by the pump 11 can be directed to other productive functions (e.g., the stick 55, the other system 56, the bucket 52, etc.).

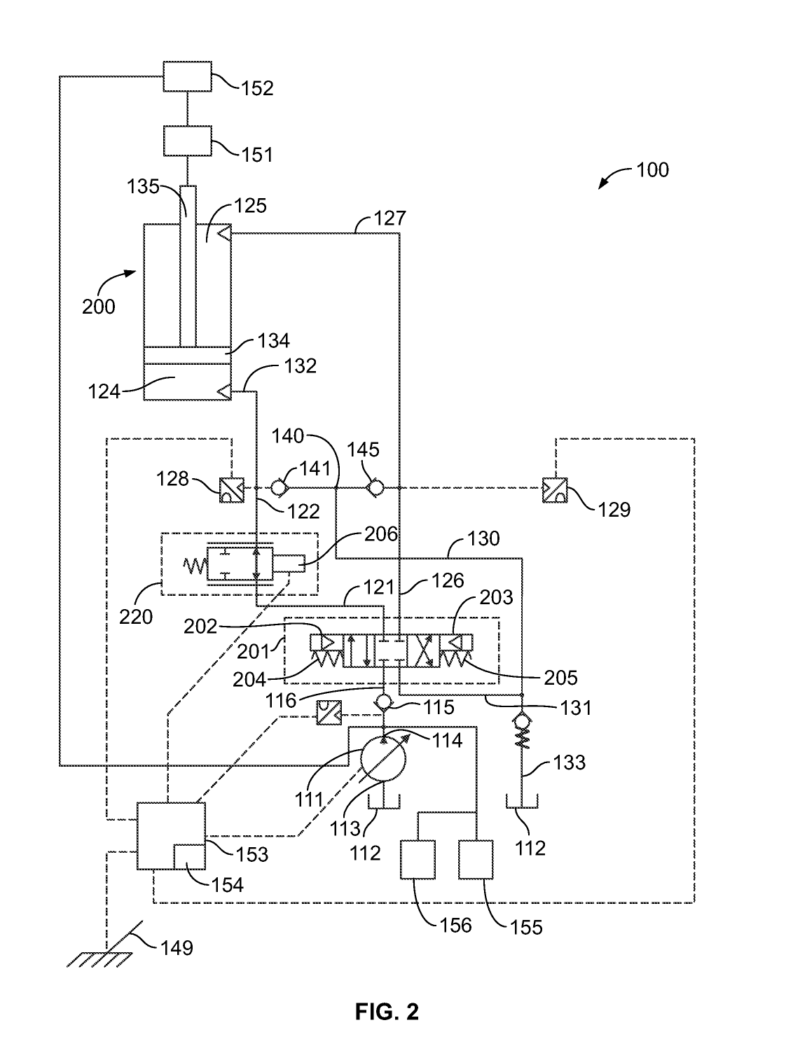

Turning to FIG. 2, another exemplary embodiment of a hydraulic system 100 is disclosed. The system 100 may include a pump 111 that is in communication with a reservoir 112. The pump 111 may include an inlet 113 and an outlet 114. The pump 11 may also be a variable displacement unidirectional pump. The pump 111 may pump fluid past the check valve 115 to a first valve 201, referred to herein as the boom control valve 201. The boom control valve 201 may be a three position, four way control valve. The boom control valve 201 can be selectively movable between its open and closed positions.

For example, the boom control valve 201 may be hydraulically controlled with hydraulic actuators 202, 203 and return springs 204, 205 which maintain the valve 201 in a normally closed position. The boom control valve 201 may also be electrically controlled by solenoids as can be appreciated by those skilled in the art. When the hydraulic actuator 202 is activated and shifts the valve 201 to the right, the pump 111 pumps fluid through the line 116 to the line 121, which leads to a boom lift make-up control valve 220. The boom lift make-up control valve 220 may be a bidirectional control valve with a variable solenoid actuator 206. Therefore, with the boom control valve 201 shifted to the right (not shown in FIG. 2) and with the boom lift make-up control valve 220 open or shifted to the left (as shown in FIG. 2), the pump is able to pump fluid through the lines 116, 121, 122 and 132 before the fluid arrives at the head end 124 of the actuator 200.

The actuator 200 may also include a rod end 125, a rod 135 and a piston 134. To deliver fluid to the rod end 125 of the actuator 200, the boom control valve 201 may be shifted to the left so that fluid from the pump 11 is routed to the lines 126, 127 before entering the rod end 125 of the actuator 200. The head end 124 and rod end 125 pressures may be detected by the sensors 128, 129 respectively.

Make-up fluid may be provided to both the head end 124 and rod end 125 of the actuator 200 via the return line 131 and make-up line 130. The make-up fluid will flow through the junction 140 and past the check valves 141, 145, depending upon the pressure in the lines 132, 127 respectively as measured by the pressure sensors 128, 129 respectively. Similar to the embodiment shown in FIG. 1, the system 100 of FIG. 2 may also include a controller 153 with a memory 154 having make-up flow control software stored thereon. Thus, the make-up circuit of the system 100 of FIG. 2 may include the line 131, the line 130, the check valve 141, the line 132 as well as the line 127.

To conserve energy when the actuator 200 is operating in an overrunning load condition, the condition is first detected by the controller 153 based upon the signals generated by the head end pressure sensor 128 and rod end pressure sensor 129, as well as the boom lever command generated at the boom lever 149, which is an extension command or a command to extend the boom.

In an overrunning load condition, the first step in conserving energy is to at least partially close the boom lift make-up control valve 220 by shifting the valve 220 to the right (not shown in FIG. 2), while the boom control valve 201 has been shifted to the right (not shown in FIG. 2). This action at least partially stops the flow of fluid from the pump 111 to the head end 124 of the actuator 200. Then, the boom lift make-up control valve 220 is at least partially closed thereby inhibiting flow from the pump 11 to the head end 124 of the actuator 200. Once the controller 153 detects a change in the work condition and that the overrunning load condition has ceased as described above, the controller 153 will then send a signal to open the boom lift make-up control valve 220 with the boom control valve 201 shifted to the right thereby reestablishing communication between the pump 111 and the head end 124 of the actuator 200.

When the boom make-up control valve 220 is in the closed position, fluid from the return line 130 can be used as make-up fluid for the head end 124. Fluid is directed to the head end 124 of the actuator through line 130 to junction 140 and make-up check valve 141 and through line 132.

The systems 10, 100 may detect an overrunning load condition as follows. First, the booms 51, 151 are in an extended position as indicated by the position of the boom levers 49, 149, which are also linked to the controller 53. When the booms 51, 151 are extended, and the work implements 52, 152 are used for digging, the pressure in the head ends 24, 124 of the actuators 20, 200 may become less than the pressures in the rod ends 25, 125 of the actuators 20, 200 respectively. In other words, with the booms 51, 151 extended, the pressure in the head ends 24, 124 should be greater than the pressures in the rod ends 25, 125. However, once a digging or similar work operation begins using the work implements 52, 152 with the booms 51, 151 extended, the pressures in the head ends 24, 124 drop below the pressures in the rod ends 25, 125, which provides an unambiguous indication to the controllers 53, 153 that the actuators 20, 200 are in an overrunning load condition.

To save energy, flow from the pumps 11, 111 to the actuators 20, 200 may be stopped or reduced because the flow being provided by the pumps 11, 111 can be better used elsewhere on the machine, such at the buckets or work implements 52, 152, sticks 55, 155 or other systems 56, 156. Therefore, the PCHE valve 36 and the boom lift make-up control valve 220 may be at least partially closed. Then, the CTHE valve 38 of the system 10 may be at least partially opened.

Referring to the system 10 of FIG. 1, at least partially opening the valve 38 enables fluid to pass through the lines 31, and 23 and serve as make-up fluid for the head end 24 of the actuator 20. Similarly, referring to the system 100 of FIG. 2, shifting the boom control valve 201 to the left enables fluid in the line 121 to be communicated to the line 131 and into the line 130 to the junction 140 where it can be used as make-up fluid for either the head end 124 or rod end 125 of the actuator 200. Shifting the boom control valve 201 to the left while the boom make-up control valve 22 is closed enables make-up fluid from the rod end 125 to be communicated to the head end 124 described above.

### INDUSTRIAL APPLICABILITY

Accordingly, hydraulic systems and methods are disclosed for conserving energy when a actuator, such as a boom actuator, is in an overrunning load condition. During such a condition, the pressure in the head end of an actuator is much lower than that of the rod end of the actuator. This is typically caused by a digging operation being carried out.

In order to reduce the energy consumption by boom actuator, the valve that provides communication between the pump and the head end of the actuator is closed or at least partially closed and the energy of the pump is directed elsewhere or to another hydraulic circuit or system on the machine.

What is claimed is:

1. A hydraulic system comprising:
a hydraulic actuator having a head end and a rod end;
a pump configured to pump supply fluid to the rod and head ends of the actuator;
a first valve fluidly coupled between the pump and the actuator;
a make-up circuit fluidly coupled between the return line and the head end of the actuator for communicating make-up fluid between a return line and the head end of the actuator;
a second valve fluidly coupled to the make-up circuit;
the system having a first configuration where the actuator is moved from a retracted position to an extended position for a period of time,
wherein for an initial segment of the period of time, the first valve is operable to at least partially reduce the supply fluid being directed to the head end of the actuator, and the second valve is operable to at least partially permit make-up fluid to be directed from the return line to the head end of the actuator; and
wherein subsequent to the initial segment of the period of time, the first valve is operable to at least partially permit supply fluid to be directed to the head end of the actuator, and the second valve is operable to at least partially inhibit make-up fluid from being directed to the head end of the actuator.

2. The system of claim 1, wherein the system further includes a head end pressure sensor and a rod end pressure sensor linked to a controller for sending signals to the controller.

3. The system of claim 2, wherein the system further includes a boom lever linked to the controller for sending lever commands to the controller, and wherein the head and rod end pressure sensors are linked to the controller, the controller having a memory with a program stored therein, the program detecting whether the hydraulic system is in an overrunning load condition based on signals received by the controller from the head and rod end pressure sensors and/or a lever command received from the boom lever.

4. The system of claim 3, wherein the first valve is at least partially closed during an overrunning load condition.

5. The system of claim 4, wherein the second valve is at least partially open during an overrunning load condition.

6. The system of claim 3, further including a bidirectional valve disposed between the pump and the head end of the actuator.

7. The system of claim 3 wherein the controller is part of an engine control module.

8. A machine comprising:
a boom coupled to a work implement;
a hydraulic system to actuate the boom and work implement, the hydraulic system including
a hydraulic actuator having a head end and a rod end;
a head end pressure sensor, a rod end pressure sensor and a boom lever, the head end and rod end pressure sensors linked to a controller for sending signals to the controller, a boom lever linked to the controller for sending lever commands to the controller, the controller having a memory with a program stored therein, the program detecting whether the hydraulic system is in an overrunning load condition based on signals received by the controller from the head end and rod end pressure sensors and a lever command;
a pump configured to supply fluid to the rod and head ends of the actuator through at least one valve;
the controller configured to control the at least one valve to reduce flow from the pump to the head end of the actuator and to increase flow from a make-up circuit to the head end of the actuator when an overrunning load condition is detected; and
the controller configured to control the at least one valve to increase flow from the pump to the head end of the actuator and to decrease flow from the make-up circuit to the head end of the actuator when the overrunning load condition has ceased.

9. The machine of claim 8, wherein the controller is part of an engine control module.

10. The machine of claim 8, wherein the at least one valve includes a first valve disposed between the pump and the head end of the hydraulic actuator, the controller at least partially closing the first valve during an overrunning load condition and at least partially opening the first valve when the overrunning load condition has ceased.

11. The machine of claim 10, wherein the at least one valve further includes a second valve disposed between the head end of the hydraulic actuator and the reservoir valve, the controller at least partially opening the second valve during the overrunning load condition and at least partially closing the second valve when the overrunning load condition has ceased.

12. The machine of claim 8, wherein the at least one valve includes a bidirectional valve disposed between the pump and the head end of the actuator.

13. The machine of claim 8 wherein the pump is a one-way pump.

14. The machine of claim 12 wherein the bidirectional valve provides flow from the pump to the head end of the actuator when the bidirectional valve is in an open position.

15. The machine of claim 14 wherein the bidirectional valve may be adjusted from a fully closed position to a fully open position and a plurality of positions therebetween.

16. A method for conserving energy in a hydraulic system including a pump, a hydraulic actuator having a head end and a rod end, a head end pressure sensor, a rod end pressure sensor and at least one valve disposed between the pump and the actuator, the method comprising:
detecting when the hydraulic system is in an overrunning load condition;
reducing fluid flow from pump to the head end of the actuator and increasing fluid flow from a make-up circuit to the head end of the actuator during the overrunning load condition by at least partially closing the at least one valve; and
increasing fluid flow from pump to the head end of the actuator and decreasing fluid flow from the make-up circuit to the head end of the actuator when the overrunning load condition has ceased by at least partially opening the at least one valve.

17. The method of claim 16, wherein the at least one valve includes a first valve between the pump and the head end of the hydraulic actuator,
the method further including at least partially closing the first valve during an overrunning load condition; and
at least partially opening the first valve when the overrunning load condition has ceased.

18. The method of claim 17, wherein the at least one valve further includes a second valve between the head end of the hydraulic actuator and the reservoir,
the method further including increasing flow from a return line to the head end of the actuator by opening the second valve during the overrunning load condition; and
closing the second valve when the overrunning load condition has ceased.

19. The method of claim 16, wherein the at least one valve includes a first bidirectional valve disposed between the pump and the head end of the actuator and a second control valve disposed between the bidirectional valve and the pump,
the method further including at least partially closing the second control valve to a position providing communication between the head end of the actuator and the make-up circuit during an overrunning load condition; and
opening the second control valve when the overrunning load condition has ceased.

20. The method of claim 16, wherein the return line passes through the second valve and a make-up check valve is disposed in parallel with the second valve.
